(19) United States
(12) Patent Application Publication
(10) Pub. No.: US 2025/0155980 A1
(43) Pub. Date: May 15, 2025

(54) HAPTIC PRESENTATION DEVICE

(71) Applicant: SONY GROUP CORPORATION, TOKYO (JP)

(72) Inventor: KENTARO YOSHIDA, TOKYO (JP)

(21) Appl. No.: 18/833,459

(22) PCT Filed: Dec. 21, 2022
(86) PCT No.: PCT/JP2022/047031

§ 371 Date: Jul. 26, 2024

(30) Foreign Application Priority Data
Feb. 4, 2022 (JP) 2022-016362

(51) Int. Cl. G06F 3/01

(52) U.S. Cl. CPC G06F 3/016

(57) ABSTRACT

To provide a haptic presentation device that is capable of effectively presenting a haptic sensation to a user. A haptic presentation device according to the present technology includes: a fixed portion; and a deformable portion. The fixed portion is capable of coming into contact with a body of a user. The deformable portion includes a first side that is a side closer to the fixed portion and a second side that is a side farther from the fixed portion and has rigidity lower than rigidity of the first side, and is capable of coming into contact with the body of the user by deformation.

### TECHNICAL FIELD

The present technology relates to a haptic presentation device that presents a haptic sensation to a user.

### BACKGROUND ART

From the past, various haptic presentation apparatuses that present a haptic sensation to a user have been known.

For example, the following Patent Literature 1 discloses a haptic sensation output apparatus of a type that is worn on a finger for use. This haptic sensation output apparatus includes a compression spring that biases a contact material coming into contact with a finger from the side opposite to the finger, and a dielectric elastomer that attracts the contact material to the side opposite to the finger side. In this haptic sensation output apparatus, by adjusting the voltage to be applied to the dielectric elastomer, the dielectric elastomer is relaxed and contracted to cause the contact material to move, thereby changing the haptic sensation to be given to the user's finger.

### CITATION LIST

### Patent Literature

Patent Literature 1: Japanese Patent Application Laid-open No. 2017-79034

### DISCLOSURE OF INVENTION

### Technical Problem

In such a field, there is a need for a haptic presentation device that is capable of effectively presenting a haptic sensation to a user.

In view of the circumstances as described above, it is an object of the present technology to provide a haptic presentation device that is capable of effectively presenting a haptic sensation to a user.

### Solution to Problem

A haptic presentation device according to the present technology includes: a fixed portion; and a deformable portion.

The fixed portion is capable of coming into contact with a body of a user.

The deformable portion includes a first side that is a side closer to the fixed portion and a second side that is a side farther from the fixed portion and has rigidity lower than rigidity of the first side, and is capable of coming into contact with the body of the user by deformation.

As a result, it is possible to provide a haptic presentation device that is capable of effectively presenting a haptic sensation to a user.

In the above haptic presentation device, the deformable portion may have a predetermined thickness in a height direction and may be deformable so as to protrude toward the height direction.

In the above haptic presentation device, a thickness of the second side may be thinner than a thickness of the first side.

In the above haptic presentation device, the deformable portion may have a thickness that gradually decreases from the first side to the second side.

In the above haptic presentation device, the deformable portion may have a first surface that is capable of coming into contact with the body of the user, and the deformable portion may be switched between a first state and a second state by deformation, the first surface being in contact with the body of the user over a first area in the first state, the first surface being in contact with the body of the user over a second area larger than the first area in the second state.

In the above haptic presentation device, a feeling of hardness and softness may be presented to the user by switching between the first state and the second state.

In the above haptic presentation device, vibration may be presented to the user by switching between the first state and the second state.

In the above haptic presentation device, the deformable portion may protrude in the height direction in the second state more than in the first state.

In the above haptic presentation device, the second side of the deformable portion may protrude in the height direction more than the first side in the second state.

In the above haptic presentation device, the deformable portion may include a first portion and a second portion, the first portion having a first height in the first state, the second portion having a height lower than the first height in the first state.

In the above haptic presentation device, the deformable portion may have a first back surface opposite to the first surface, and the haptic presentation device may further include: a fluid holding portion that is capable of holding fluid and provided on a side of the first back surface of the deformable portion; and a fluid drive unit that switches between the first state and the second state by changing pressure of the fluid in the fluid holding portion.

In the above haptic presentation device, the fixed portion may have a second surface that is capable of coming into contact with the body of the user and a second back surface opposite to the second surface, and the haptic presentation device may further include a support portion that supports and fixes the fixed portion from a side of the second back surface.

The above haptic presentation device may further include an output unit that presents a sensation to the user via the fixed portion.

In the above haptic presentation device, the output unit may include at least one of a vibration generation unit that generates vibration, a temperature change unit that changes temperature, a pressure generation unit that generates pressure, a sound output unit that outputs sound, or a light-emitting unit that generates light.

In the above haptic presentation device, the output unit may include the vibration generation unit, and the haptic presentation device may present vibration in a first frequency band to the user by switching between the first state and the second state and present vibration in a second frequency band different from the first frequency band to the user by vibration of the vibration generation unit.

The above haptic presentation device may further include a control unit that executes, on a basis of predetermined information, switching between the first state and the second state or presentation of a sensation to the user by the output unit.

The above haptic presentation device may further include a sensor unit that detects an action of the user on the fixed portion.

In the above haptic presentation device, the sensor unit may include at least one of a proximity sensor, a vibration sensor, a temperature sensor, a pressure sensor, a sound sensor, a sound detection sensor, or a light receiving sensor.

The above haptic presentation device may further include a control unit that switches between the first state and the second state on a basis of information from the sensor unit.

In the above haptic presentation device, the deformable portion may be disposed so as to surround the fixed portion.

### BRIEF DESCRIPTION OF DRAWINGS

FIG. 1 is a schematic top view showing a haptic presentation device according to a first embodiment.

FIG. 2 is a schematic cross-sectional view of the haptic presentation device according to the first embodiment as viewed from the front and is a diagram showing an initial state of the haptic presentation device.

FIG. 3 is a schematic cross-sectional view of the haptic presentation device according to the first embodiment as viewed from the front and is a diagram showing a deformed state of the haptic presentation device.

FIG. 4 is a diagram showing First Example in processing of a control unit.

FIG. 5 is a diagram showing Second Example in the processing of the control unit.

FIG. 6 is a diagram showing Third Example in the processing of the control unit.

FIG. 7 is a perspective view showing a haptic presentation device according to an application example.

FIG. 8 is a cross-sectional view of the haptic presentation device according to the application example as viewed from the front.

FIG. 9 is a cross-sectional view of the haptic presentation device according to the application example as viewed from the front.

FIG. 10 is a cross-sectional view of the haptic presentation device according to the application example as viewed from the side.

FIG. 11 is a cross-sectional view of the haptic presentation device according to the application example as viewed from the side.

FIG. 12 is a top view showing a haptic presentation device according to Comparative Example.

FIG. 13 is a side view showing a deformed state of the haptic presentation device according to Comparative Example.

FIG. 14 is a diagram showing a deformed state of a deformable portion according to the present technology.

FIG. 15 is a diagram showing a haptic presentation device according to a first modified example.

FIG. 16 is a diagram showing a haptic presentation device according to a second modified example.

FIG. 17 is a diagram showing a haptic presentation device according to a third modified example.

FIG. 18 is a diagram showing a haptic presentation device according to a fourth modified example.

FIG. 19 is a diagram showing a haptic presentation device according to a fifth modified example.

FIG. 20 is a diagram showing a haptic presentation device according to a sixth modified example.

### MODE(S) FOR CARRYING OUT THE INVENTION

Hereinafter, embodiments according to the present technology will be described with reference to the drawings.

### First Embodiment

### Overall Configuration and Configurations of Respective Units

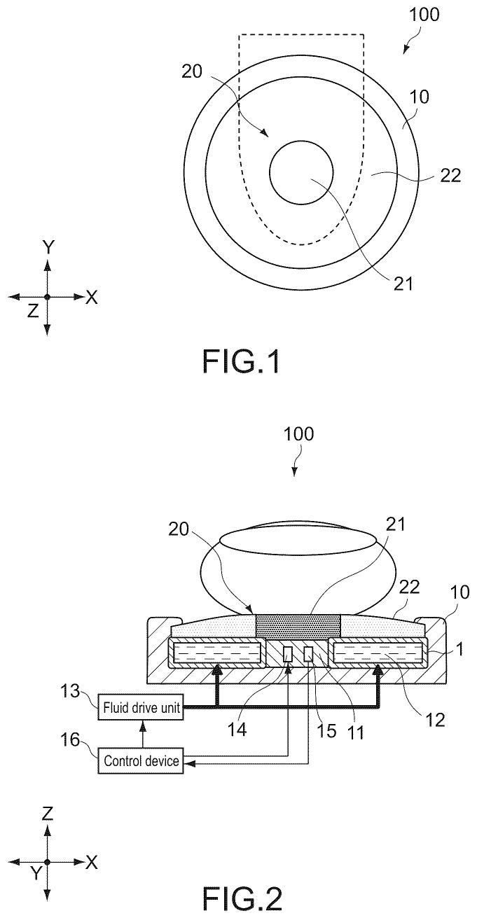

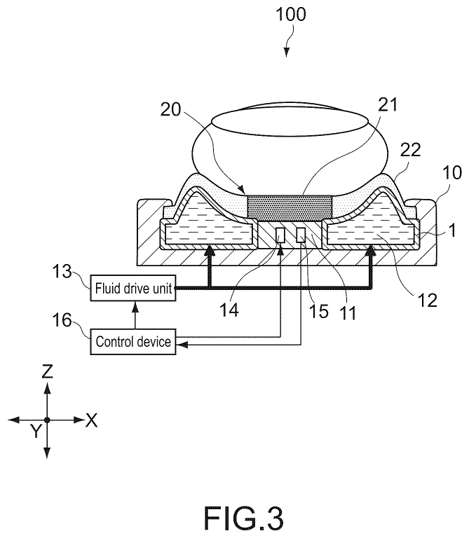

FIG. 1 is a schematic top view showing a haptic presentation device 100 according to a first embodiment. FIG. 2 is a schematic cross-sectional view of the haptic presentation device 100 according to the first embodiment as viewed from the front and is a diagram showing an initial state of the haptic presentation device 100. FIG. 3 is a schematic cross-sectional view of the haptic presentation device 100 according to the first embodiment as viewed from the front and is a diagram showing a deformed state of the haptic presentation device 100.

The haptic presentation device 100 may be an installation-type device that is installed at a predetermined location such as on a table and used, or may be a wearable-type device that is worn on the user's body (finger).

As shown in these figures, the haptic presentation device 100 according to this embodiment includes a bottomed cylindrical casing 10 and a support portion 11 that is erected on the bottom portion of the casing 10. Further, the haptic presentation device 100 includes a film portion 20 that is capable of coming into contact with the body of the user, a fluid holding portion 12 that holds fluid, and a fluid drive unit 13 that controls flow of the fluid into and out of the fluid holding portion 12.

Further, the haptic presentation device 100 includes an output unit 14 that is provided in the support portion 11 and for presenting a sensation to a user, and a sensor unit 15 that is provided in the support portion 11. Further, the haptic presentation device 100 includes a control device 16 that integrally controls the respective units of the haptic presentation device 100.

The casing 10 has a bottomed cylindrical shape with the top open. Although the shape of the cylinder in the casing 10 is circular in the example shown in the figure, the shape of the cylinder may be any shape such as an ellipse shape, a polygonal shape, and a star shape. The casing 10 is formed of various materials such as a resin and a metal. Note that in the case where the haptic presentation device 100 is of a wearable-type, for example, a band or the like for fixing the user's finger may be provided on the outer peripheral surface of the casing 10.

The support portion 11 is erected on the bottom portion of the casing 10 at the center position thereof (XY direction) and has a columnar shape. Although the shape of the column in the support portion 11 is circular in the example shown in the figure, the shape of the column may be any shape such as an ellipse shape, a polygonal shape, and a star shape. The support portion 11 may be formed of various materials such as a resin and a metal. The support portion 11 may be integrally formed of the same material as that of the casing 10 or may be formed of a material different from that of the casing 10.

The film portion 20 is exposed above the haptic presentation device 100 and is capable of coming into contact with the body of the user, such as a finger. The film portion 20 is a portion that presents a haptic sensation to a user when touched by the user. In the example here, assumption is made that the target to be presented with a haptic sensation is the user's finger. The target to be presented with a haptic sensation is not limited to the finger, and may be any part of the user's body, such as the palm, arm, head, face, leg, foot, and toe.

The film portion 20 includes a deformable portion 22 that is deformable by flow of fluid into and out of the fluid holding portion 12, and a fixed portion 21 that is fixed on the support portion 11 and is not deformed by flow of fluid into and out of the fluid holding portion 12.

The fixed portion 21 is formed in, for example, a disc shape. Note that the fixed portion 21 may have any shape such as an ellipse shape, a polygonal shape, and a star shape. The fixed portion 21 has a surface (second surface) that is capable of coming into contact with a body of a user, and a back surface (second back surface) opposite to this surface. The support portion 11 supports and fixes the fixed portion 21 from the back surface side.

The area (XY direction) of the surface of the fixed portion 21 is set to be slightly smaller than the size of a finger, so that when a user touches the surface of the fixed portion 21 with his/her finger, the entire surface of the fixed portion 21 can be touched.

The deformable portion 22 is capable of coming into contact with a body of a user by deformation. The deformable portion 22 is a portion of the film portion 20 other than the fixed portion 21. The deformable portion 22 is configured to have a disc shape excluding the central portion (fixed portion 21) in the planar direction. Note that the deformable portion 22 may have any shape such as an ellipse shape, a polygonal shape, and a star shape.

The deformable portion 22 is provided so as to surround the fixed portion 21. Although the deformable portion 22 is provided so as to surround the entire circumference of the fixed portion 21 in the example shown in the figure, the deformable portion 22 may be provided so as to surround at least part of the periphery of the fixed portion 21.

The deformable portion 22 has a front surface (first surface) and a back surface (first back surface) opposite to the front surface. The fluid holding portion 12 is provided on the back surface side of the deformable portion 22, and deforms the deformable portion 22 by the outflow and inflow of fluid.

The deformable portion 22 has an inner peripheral side connected to the fixed portion 21 and an outer peripheral side fixed to the upper part of the casing 10. The deformable portion 22 has a predetermined thickness in the height direction and is deformable so as to protrude toward the height direction. The deformable portion 22 has a thickness that is thinner on the outer peripheral side (second side that is a side farther from the fixed portion 21) than on the inner peripheral side (first side that is closer to the fixed portion 21).

Specifically, the deformable portion 22 is configured to have a thickness that gradually decreases from the inner peripheral side to the outer peripheral side. For this reason, the deformable portion 22 has lower rigidity on the outer peripheral side than on the inner peripheral side. Therefore, the deformable portion 22 deforms more easily on the outer peripheral side than on the inner peripheral side (see FIG. 3).

The deformable portion 22 is switched between an initial state (first state) (see FIG. 2) and a deformed state (second state) (see FIG. 3) by deformation, the front surface (first surface) of the deformable portion 22 being in contact with a body (finger) of a user over a first area (including zero) in the initial state, the front surface of the deformable portion 22 being in contact with the body (finger) of the user over a second area larger than the first area in the deformed state.

The initial state is, for example, a state in which no force is applied to the deformable portion 22, the deformable portion 22 is not deformed, and the pressure inside the fluid holding portion 12 is equal to the atmospheric pressure. The deformed state is, for example, a state in which the deformable portion 22 is deformed by a force applied to the deformable portion 22 from the back surface side and the pressure inside the fluid holding portion 12 is larger than the atmospheric pressure. The deformed state includes multiple stages of deformed states from a small deformation state to a large deformation state.

As shown in FIG. 3, in the deformed state, the deformable portion 22 is deformed so as to protrude in the height direction (toward the user' body) than in the initial state. In particular, in this embodiment, in the deformed state, the deformable portion 22 protrudes in the height direction on the outer peripheral side that is relatively thin (low rigidity and easy to deform) more than on the inner peripheral side that is relatively thick (high rigidity and difficult to deform). For this reason, the deformable portion 22 is deformable according to the shape or curvature of the user's finger.

The deformable portion 22 is formed of a material with high stretchability, e.g., various types of rubber such as silicon rubber, urethane rubber, and natural rubber, or mesh fabric. From the viewpoint of cost reduction, the fixed portion 21 is typically formed of the same material as that of the deformable portion 22, but the fixed portion 21 may be formed of a material different from that of the deformable portion 22. For example, the fixed portion 21 may be formed of a material with low stretchability, such as a metal, a resin, and wood.

Note that in the above example, a case where the thickness is changed between the inner peripheral side and the outer peripheral side of the deformable portion 22 in order to make the outer peripheral side of the deformable portion 22 lower in rigidity than the inner peripheral side to make it easier to deform has been described. Meanwhile, in order to make the outer peripheral side of the deformable portion 22 lower in rigidity than the inner peripheral side to make it easier to deform, the material may be changed between the inner peripheral side and the outer peripheral side of the deformable portion 22.

In this case, for example, as the material of the outer peripheral side of the deformable portion 22, a material having a lower Young's modulus (e.g., the thickness is the same) than the material of the inner peripheral side is used. Alternatively, in order to make the outer peripheral side of the deformable portion 22 lower in rigidity than the inner peripheral side to make it easier to deform, both the thickness and material may be changed between the inner peripheral side and the outer peripheral side of the deformable portion 22.

The fluid holding portion 12 is formed by a space below the deformable portion 22 (on the side opposite to the user side) and is capable of holding fluid with airtightness. The space forming the fluid holding portion 12 is a region surrounded by the back surface of the deformable portion 22, the bottom surface of the casing 10, the inner wall surface of the casing 10, and the outer peripheral surface of the support portion 11.

Although the shape of the space of the fluid holding portion 12 is a ring shape having a predetermined height in the example shown in the figure, this shape can be changed as appropriate. The space of the fluid holding portion 12 may be covered with a film member 1. This film member 1 is formed of various types of rubber such as silicon rubber, urethane rubber, and natural rubber from the viewpoint of maintaining the airtightness of the space while having stretchability (in the case of covering the part in contact with the deformable portion 22 with the film member 1).

The fluid held by the fluid holding portion 12 may be various gases such as air and nitrogen gas, or may be a liquid such as water, magnetic fluid, and electrorheological fluid.

The output unit 14 for presenting a sensation to a user via the fixed portion 21 (and the support portion 11) is provided inside the support portion 11. Further, the sensor unit 15 for detecting an action of a user on the fixed portion 21 is provided inside the support portion 11. Note that the output unit 14 and the sensor unit 15 may be provided outside the support portion 11 (e.g., above or below the support portion 11).

The output unit 14 is electrically connected to the control device 16, and presents a sensation to a user in accordance with the control of the control device 16. The output unit 14 includes at least one of a vibration generation unit that generates vibration, a temperature change unit that changes temperature, a pressure generation unit that generates pressure, a sound output unit that outputs sound, or a light-emitting unit that generates light.

The vibration generation unit includes, for example, a voice coil motor, a piezoelectric element, an eccentric motor, an LRA (Linear Resonant Actuator), and the like, and presents vibration to a user. The temperature change unit includes, for example, a Peltier element, a heater, and the like, and presents a warm or cool sensation to a user. The pressure generation unit includes an electromagnetic motor, an electrostatic actuator, a compressor (air pressure, hydraulic pressure), and the like, and presents pressure (force) to a user.

The sound output unit includes, for example, a speaker and presents sound to a user. The light-emitting unit includes, for example, an LED (Light Emitting Diode) and presents light to a user.

The sensor unit 15 is electrically connected to the control device 16 and transmits detected information to the control device 16. The sensor unit 15 includes at least one of a proximity sensor, a vibration sensor, a temperature sensor, a pressure sensor, a sound detection sensor, or a light receiving sensor.

The proximity sensor includes a capacitive sensor, an optical distance sensor, a conduction sensor, an illuminance sensor, or the like, and detects the proximity or contact of the finger (body) of the user to the fixed portion 21. The vibration sensor detects vibration of the fixed portion 21 caused by the user's finger. The temperature sensor is a thermocouple sensor, a resistance sensor, or the like, and detects the change in temperature of the fixed portion 21 caused by the user's finger.

The pressure sensor includes a resistance-change sensor, a capacitance-change sensor, or the like, and detects the pressure applied to the fixed portion 21 by the user's finger. The sound detection sensor is, for example, a microphone, and detects sound (voice) generated by the user. The light receiving sensor is, for example, an image sensor of a camera and images the user's finger via the fixed portion 21.

Note that in the case where the output unit 14 includes a temperature generation unit or the sensor unit 15 includes a temperature sensor, a material having a relatively high thermal conductivity (e.g., 0.1 W/mK or more) is used as the material of the fixed portion 21.

Further, in the case where the output unit 14 includes a vibration generation unit and a sound generation unit or the sensor unit 15 includes a vibration sensor and a sound detection sensor, a material having a relatively high Young's modulus (1.0 MPa or more) is used as the material of the fixed portion 21. Further, in the case where the output unit 14 includes a light-emitting unit or the sensor unit 15 includes a light receiving sensor, a material having relatively high transmittance (e.g., 0.5 or more) is used as the material of the fixed portion 21.

The fluid drive unit 13 is capable of switching between the initial state and the deformed state (multiple stages) in the deformable portion 22 by changing the pressure of the fluid in the fluid holding portion 12. The fluid drive unit 13 is connected to the fluid holding portion 12 via a pipe or the like having a flow path of fluid. The fluid drive unit 13 includes a pump, an electromagnetic valve, and the like.

The control device 16 includes a control unit, a storage unit, a communication unit, and the like. The control unit executes various calculations on the basis of various programs stored in the storage unit and integrally controls the respective units of the haptic presentation device 100.

The control unit is capable of driving the fluid drive unit 13 under its control to switch between the initial state and the deformed state (multiple stages) in the deformable portion 22. Further, the control unit is capable of driving the output unit 14 on the basis of predetermined information (including sensor information from the sensor unit 15) to presenting a sensation to a user via the fixed portion 21.

The control unit is realized by hardware or a combination of hardware and software. The hardware is configured as part or all of the control unit. Examples of this hardware include a CPU (Central Processing Unit), a DSP (Digital Signal Processor), an FPGA (Field Programmable Gate Array), ASIC (Application Specific Integrated Circuit), and those similar to these.

The storage unit includes a non-volatile memory in which various programs necessary for processing by the control unit and various types of data are stored, and a volatile memory used as a work area of the control unit. The communication unit is configured to be capable of communicating with other devices other than the haptic presentation device 100.

Note that the control device 16 may be a device dedicated to the haptic presentation device 100 (e.g., a microcontroller), or another general-purpose device such as a PC (Personal Computer: a desktop PC, a laptop PC, a tablet PC, a server apparatus a network, etc.) and a mobile phone (including a smartphone).

### Usage Example

In this embodiment, by switching between the initial state and the deformed state of the deformable portion 22, it is possible to present hard and soft sensations to a user. For example, in the case where it is desired to present a hard haptic sensation to a user, the deformable portion 22 is set to the initial state (see FIG. 2). Meanwhile, in the case where it is desired to present a soft haptic sensation to a user, the deformable portion 22 is set to the deformed state (see FIG. 3).

Further, in this embodiment, by switching between the initial state and the deformed state of the deformable portion 22, it is possible to present vibration to a user. For example, by switching between the initial state (see FIG. 2) and the deformed state (see FIG. 3) of the deformable portion 22 at a predetermined period, it is possible to present vibration to a user.

Further, in this embodiment, by combining presentation of a sensation by the output unit 14 with the presentation of a haptic sensation by switching between the initial state and the deformed state (multiple stages) of the deformable portion 22, it is possible to present various sensations to a user.

For example, assumption is made that hard and soft sensations are presented to a user by switching between the initial state and the deformed state of the deformable portion 22. In this case, for example, by lowering the temperature of the fixed portion 21 by the temperature change unit when the deformable portion 22 is set to the initial state to present a hard haptic sensation to a user, it is possible to present, to the user, a sensation as if he/she touches metal. Further, by increasing the temperature of the fixed portion 21 by the temperature change unit when the deformable portion 22 is set to the initial state (or the deformed state in which it is slightly deformed) to present a hard haptic sensation to a user, it is possible to present, to the user, a sensation as if he/she touches wood.

Further, for example, by vibrating the fixed portion 21 at a predetermined frequency by the vibration generation unit when the deformable portion 22 is set to the initial state to present a hard haptic sensation to a user, it is possible to present, to the user, a sensation as if he/she touches metal. Further, by vibrating the fixed portion 21 at a predetermined frequency (frequency different from that in the case of metal) by the vibration generation unit when the deformable portion 22 is set to the initial state (or the deformed state in which it is slightly deformed) to present a hard haptic sensation to a user, it is possible to present, to the user, a sensation as if he/she touches wood.

Note that by combining the temperature and vibration described here, it is also possible to present a sensation of metal, a sensation of wood, and the like to a user.

Further, assumption is made that vibration is presented to a user by switching between the initial state and the deformed state of the deformable portion 22. In this case, for example, vibration in a frequency band (first frequency band) of less than a predetermined threshold value (e.g., 20 Hz) is presented to a user by switching between the initial state and the deformed state of the deformable portion 22. Meanwhile, vibration in a frequency band (frequency band different from the first frequency band) of higher than the predetermined threshold value (e.g., 20 Hz) is presented to a user by vibration of the vibration generation unit. As a result, it is possible to appropriately present vibration in a wide frequency band to the user.

The sensor information from the sensor unit 15 can be used as at least one of information for deforming the deformable portion 22 or information for driving the output unit 14.

### Operation Description

Next, processing of the control unit in the control device 16 will be described. Note that in the description of processing here, three Examples will be given and specifically described.

### First Example

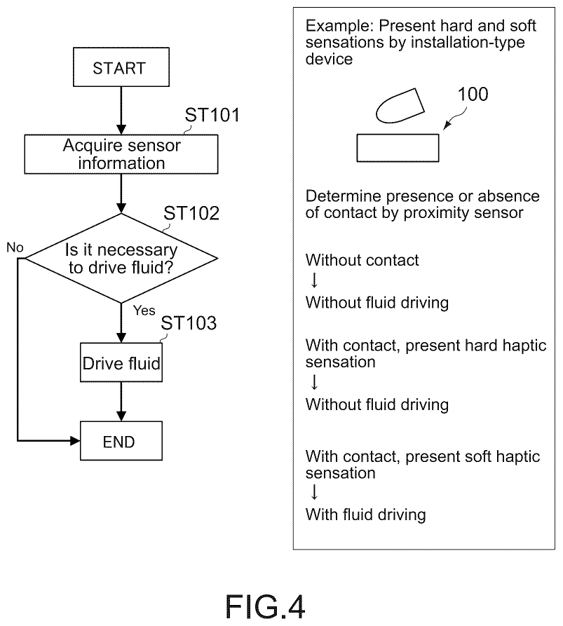

FIG. 4 is a diagram showing First Example in the processing of the control unit. First Example is an example in which the deformable portion 22 is deformed on the basis of sensor information. In the example here, a case where an installation-type haptic presentation device 100 is used and hard and soft sensations are presented to a user by deformation of the deformable portion 22 will be described as an example.

First, the control unit acquires sensor information from the proximity sensor and determines whether or not the user's finger is in proximity to (in contact with) the fixed portion 21 (Step 101). Next, the control unit determines, on the basis of the sensor information from the proximity sensor (whether or not it is in proximity to (in contact with)), whether or not it is necessary to drive the fluid drive unit 13 to deform the deformable portion 22 (Step 102).

In Step 102, in the case where the user's finger is not in proximity to (in contact with) the fixed portion 21, the control unit determines that it is not necessary to drive the fluid drive unit 13 (NO in Step 102), and ends the processing without deforming the deformable portion 22 (initial state).

Further, in Step 102, in the case where a hard haptic sensation is currently presented to a user although the user's finger is in proximity to (in contact with) the fixed portion 21, the control unit determines that it is not necessary to drive the fluid drive unit 13 (NO in Step 102), and ends the processing without deforming the deformable portion 22 (initial state).

Meanwhile, in Step 102, in the case where the user's finger is in proximity to (in contact with) the fixed portion 21 and a soft haptic sensation is currently presented to the user, the control unit determines that it is necessary to drive the fluid drive unit 13 (YES in Step 102). In this case, the control unit drives the fluid drive unit 13 to deform the deformable portion 22 (deformed state) (Step 103), and ends the processing.

Although a case where a proximity sensor is used as the sensor unit 15 has been described here, a vibration sensor, a temperature sensor, a pressure sensor, a sound detection sensor, or a light receiving sensor may be used.

For example, the presence or absence of proximity (contact) to the fixed portion 21 may be determined by the vibration sensor, the temperature sensor, or the pressure sensor. Also in this case, similarly to the above, in the case where the user's finger is in proximity to (in contact with) the fixed portion 21 and a soft haptic sensation is currently presented to the user, the control unit drives the fluid drive unit 13 to present a soft haptic sensation to the user. In the case where the pressure sensor is used, the degree of deformation of the deformable portion 22 can also be changed depending on the magnitude of the pushing force.

Further, for example, in the case where the sound detection sensor (microphone) or the light receiving sensor (camera) is used, by identifying the user's voice or identifying the user's fingerprint, it is also possible to identify an individual and change the hard and soft sensation to be presented for each user.

Although a case where hard and soft sensations are presented to a user by deformation of the deformable portion 22 on the basis of the sensor information from the sensor unit 15 has been described above, vibration (e.g., less than 20 Hz) may be presented to a user by deformation of the deformable portion 22.

For example, the presence or absence of proximity (contact) to the fixed portion 21 is determined by the proximity sensor, the vibration sensor, the temperature sensor, or the pressure sensor. In this case, in the case where the user's finger is in proximity to (in contact with) the fixed portion 21 and vibration is currently presented to the user, the control unit drives the fluid drive unit 13 to present vibration to the user. In the case where the pressure sensor is used, the frequency of vibration by the deformable portion 22 can also be changed depending on the magnitude of the pushing force.

Further for example, in the case where the sound detection sensor (microphone) or the light receiving sensor (camera) is used, by identifying the user's voice or identifying the user's fingerprint, it is also possible to identify an individual and change the frequency of vibration to be presented for each user.

### Second Example

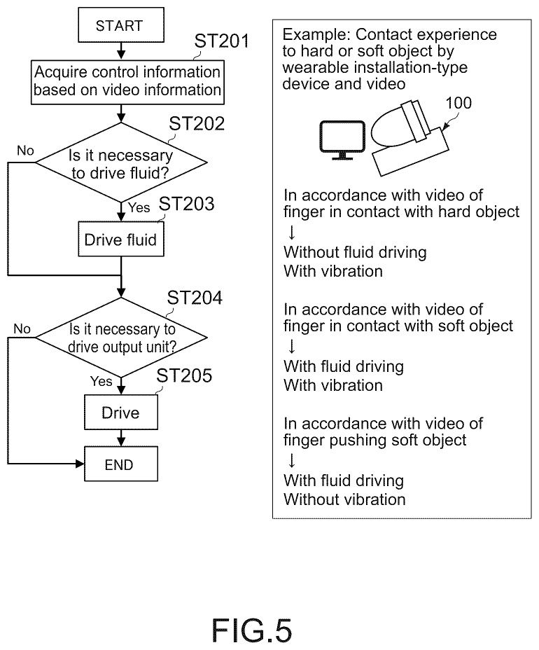

FIG. 5 is a diagram showing Second Example in the processing of the control unit. Second Example is an example in which the deformable portion 22 is deformed and the output unit 14 is driven on the basis of control information (predetermined information) based on video information. In the example here, a case where a wearable-type haptic presentation device 100 is used (i.e., the finger is constantly in contact with the fixed portion 21) and the deformable portion 22 is deformed in accordance with video displayed on the screen of the display device to present hard and soft sensations to a user will be described as an example.

First, the control unit acquires control information based on video information (Step 201). The control information includes information regarding what kind of hard and soft sensations should be presented to a user at what timing. The control information may be acquired from another apparatus (e.g., a server apparatus on a network) via the communication unit, or may be stored in the storage unit of the control device 16 in advance.

Next, the control unit determines, on the basis of the acquired control information, whether or not it is necessary to drive the fluid drive unit 13 to deform the deformable portion 22 (Step 202).

In Step 202, in the case where video of a finger in contact with a hard object is currently displayed on the screen, the control unit determines that it is not necessary to drive the fluid drive unit 13 to deform the deformable portion 22 (initial state) (NO in Step 202), and the processing proceeds to Step 204.

Further, in Step 202, in the case where video of a finger in contact with a soft object is currently displayed on the screen, the control unit determines that it is necessary to drive the fluid drive unit 13 (YES in Step 202). In this case, the control unit drives the fluid drive unit 13 to deform the deformable portion 22 (deformed state) (Step 203), and the processing proceeds to the next Step 204.

Further, in Step 202, in the case where video of a finger pushing a soft object is currently displayed on the screen, the control unit determines that it is necessary to drive the fluid drive unit 13 (YES in Step 202). In this case, the control unit drives the fluid drive unit 13 to deform the deformable portion 22 (deformed state) (Step 203), and the processing proceeds to the next Step 204.

In Step 204, the control unit determines, on the basis of the control information based on video information, whether or not it is necessary to drive the output unit 14.

In Step 204, in the case where video of a finger in contact with a hard object is currently displayed on the screen, the control unit determines that it is necessary to drive the vibration generation unit in the output unit 14 (YES in Step 204). In this case, the control unit drives the vibration generation unit to vibrate the fixed portion 21 (Step 205), and ends the processing.

Further, in Step 204, in the case where video of a finger in contact with a soft object is currently displayed on the screen, the control unit determines that it is necessary to drive the vibration generation unit in the output unit 14 (YES in Step 204). In this case, the control unit drives the vibration generation unit to vibrate the fixed portion 21 (the frequency is different from that in the case where the finger is in contact with a hard object) (Step 205), and ends the processing.

Further, in Step 204, in the case where video of a finger pushing a soft object is currently displayed on the screen, the control unit determines that it is not necessary to drive the vibration generation unit in the output unit 14 (NO in Step 204), and ends the processing.

Although a case where a vibration generation unit is used as the output unit 14 has been described here, a temperature change unit, a pressure generation unit, a sound output unit, or a light-emitting unit may be used as the output unit 14.

For example, the control unit may change the temperature of the fixed portion 21 using the temperature change unit in accordance with video of a finger in contact with a warm or cold object. In this case, when video of a finger in contact with a warm or cold hard object is displayed on the screen, the control unit increases or decreases the temperature of the fixed portion 21 by the temperature change unit without deforming the deformable portion 22 (initial state). Further, when video of a finger in contact with a warm or cold soft object is displayed on the screen, the control unit deforms the deformable portion 22 (deformed state) and increases or decreases the temperature of the fixed portion 21 by the temperature change unit.

Further, the control unit may change the pressure from below the fixed portion 21 by the pressure generation unit in accordance with video of a finger pushed back by an object. In this case, when video of a finger pushed back by a hard object is displayed on the screen, the control unit increases the pressure from below the fixed portion 21 by the pressure change unit without deforming the deformable portion 22 (initial state). Further, when video of a finger pushed back by a soft object is displayed on the screen, the control unit deforms the deformable portion 22 (deformed state) and increases the pressure from below the fixed portion 21 by the pressure change unit.

Further, the control unit may generate a sound (voice) by the sound output unit in accordance with video of a finger in contact with an object (character) that makes a sound (emits a voice). In this case, when video of a finger in contact with a hard object (character) that makes a sound (emits a voice) is displayed on the screen, the control unit causes the sound output unit to generate a sound (voice) without deforming the deformable portion 22 (initial state). Further, when video of a finger in contact with a soft object (character) that makes a sound (emits a voice) is displayed on the screen, the control unit deforms the deformable portion 22 (deformed state) and causes the sound output unit to generate a sound (voice).

Further, the control unit may cause the light-emitting unit to emit light in accordance with video of a finger in contact with an object (character) that emits light. In this case, when video of a finger in contact with a hard object (character) that emits light is displayed on the screen, the control unit causes the light-emitting unit to emit light without deforming the deformable portion 22 (initial state). Further, when video of a finger in contact with a soft object (character) that emits light is displayed on the screen, the control unit deforms the deformable portion 22 (deformed state) and causes the light-emitting unit to emit light.

Although a case where hard and soft sensations are presented to a user by deformation of the deformable portion 22 on the basis of control information based on video information has been described above, vibration (e.g., less than 20 Hz) may be presented to a user by deformation of the deformable portion 22.

For example, in the case where video of a finger in contact with a vibrating object is currently displayed on the screen, the control unit switches between the initial state and the deformed state of the deformable portion 22 to presents vibration (e.g., less than 20 Hz) to a user. In this case, in the case where vibration of a high frequency (20 Hz or more) that cannot be reproduced by switching between the initial state and the deformed state of the deformable portion 22 is presented to the user, the control unit may present vibration caused by not deformation of the deformable portion 22 but vibration of the vibration generation unit to the user.

The presentation of vibration caused by deformation of the deformable portion 22, presentation of temperature by the temperature change unit, presentation of pressure by the pressure generation unit, presentation of sound by the sound output unit, and presentation of light by the light-emitting unit may be combined.

### Third Example

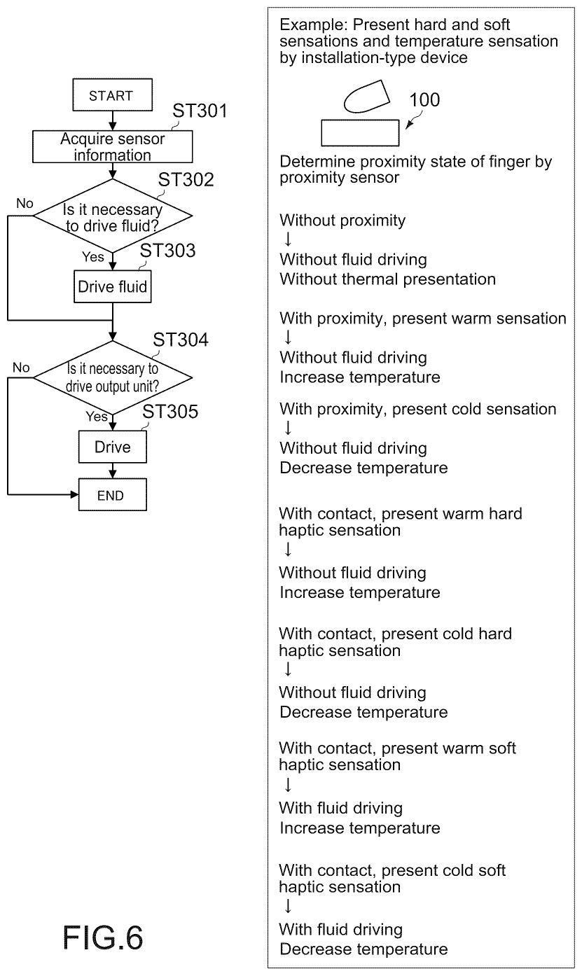

FIG. 6 is a diagram showing Third Example in the processing of the control unit. Third Example is an example in which the deformable portion 22 is deformed on the basis of the sensor information (predetermined information) from the sensor unit 15, and the output unit 14 is driven on the basis of the sensor information. In the example here, a case where an installation-type haptic presentation device 100 is used, hard and soft sensations are presented to a user by deformation of the deformable portion 22, and a temperature sensation is presented by the temperature output unit 14 will be described as an example.

The control unit acquires sensor information from the proximity sensor and determines whether or not the user's finger is in proximity to the fixed portion 21 to a predetermined distance or less and whether or not the user's finger is in contact with the fixed portion 21 (Step 301).

Next, the control unit determines, on the basis of the sensor information from the proximity sensor, whether or not it is necessary to drive the fluid drive unit 13 to deform the deformable portion 22 (Step 302).

In Step 302, in the case where the user's finger is not in proximity to the fixed portion 21 (a predetermined distance or less from the fixed portion 21), the control unit determines that it is not necessary to drive the fluid drive unit 13 (NO in Step 102), and the processing proceeds to Step 304 without deforming the deformable portion 22 (initial state).

Further, in Step 302, in the case where a hard haptic sensation is currently presented to the user although the user's finger is in contact with the fixed portion 21, the control unit determines that it is not necessary to drive the fluid drive unit 13 (NO in Step 302), and the processing proceeds to Step 304 without deforming the deformable portion 22 (initial state).

Meanwhile, in Step 302, in the case where the user's finger is in contact with the fixed portion 21 and a soft haptic sensation is currently presented to the user, the control unit determines that it is necessary to drive the fluid drive unit 13 (YES in Step 302). In this case, the control unit drives the fluid drive unit 13 to deform the deformable portion 22 (deformed state) (Step 303), and the processing proceeds to the next Step 304.

In Step 304, the control unit determines, on the basis of the sensor information from the proximity sensor, whether or not it is necessary to drive the temperature change unit to present heat to the user.

In Step 304, in the case where the user's finger is not in proximity (a predetermined distance or less from the fixed portion 21) to the fixed portion 21, the control unit determines that it is not necessary to drive the temperature change unit (NO in Step 304), and ends the processing.

Further, in Step 304, in the case where the user's finger is in proximity to the fixed portion 21 and a warm sensation is currently presented to the user, the control unit determines that it is necessary to drive the temperature change unit (YES in Step 304). In this case, the control unit drives the temperature change unit to increase the temperature of the fixed portion 21 (Step 305).

Further, in Step 304, in the case where the user's finger is in proximity to the fixed portion 21 and a cold sensation is currently presented to the user, the control unit determines that it is necessary to drive the temperature change unit (YES in Step 304). In this case, the control unit drives the temperature change unit to decrease the temperature of the fixed portion 21 (Step 305).

Further, in Step 304, the user's finger is in contact with the fixed portion 21 and a warm sensation is currently presented to the user, the control unit determines that it is necessary to drive the temperature change unit (YES in Step 304). In this case, the control unit drives the temperature change unit to increase the temperature of the fixed portion 21 (Step 305).

Further, in Step 304, in the case where the user's finger is in contact with the fixed portion 21 and a cold sensation is currently presented to the user, the control unit determine that it is necessary to drive the temperature change unit (YES in Step 304). In this case, the control unit drives the temperature change unit to decrease the temperature of the fixed portion 21 (Step 305).

Although a case where a proximity sensor is used as the sensor unit 15 has been described here, a vibration sensor, a temperature sensor, a pressure sensor, a sound detection sensor, or a light receiving sensor may be used (see First Example).

Further, a case where a temperature change unit is used as the output unit 14 has been described here, a vibration generation unit, a pressure generation unit, a sound output unit, or a light-emitting unit may be used as the output unit 14 (see Second Example).

Although a case where hard and soft sensations are presented to a user by deformation of the deformable portion 22 on the basis of sensor information from the sensor unit 15 has been described above, vibration (e.g., less than 20 Hz) may be presented to a user by deformation of the deformable portion 22.

### Application Example

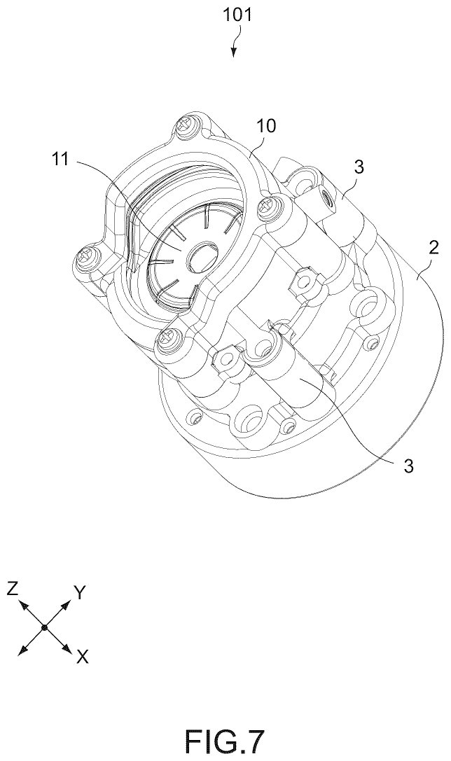

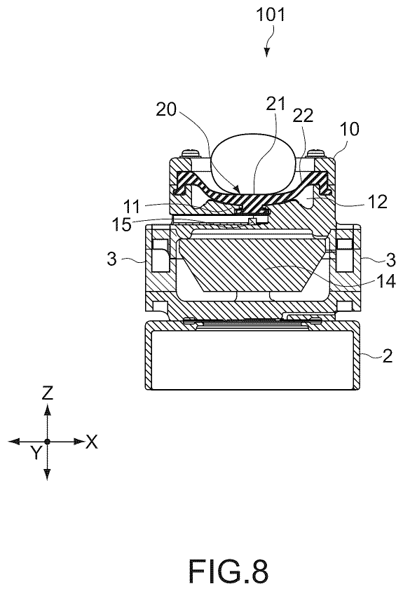

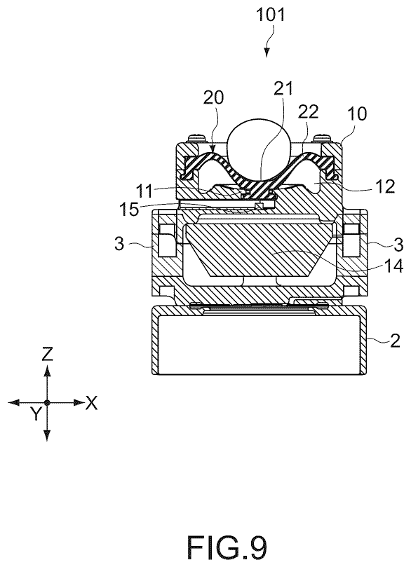

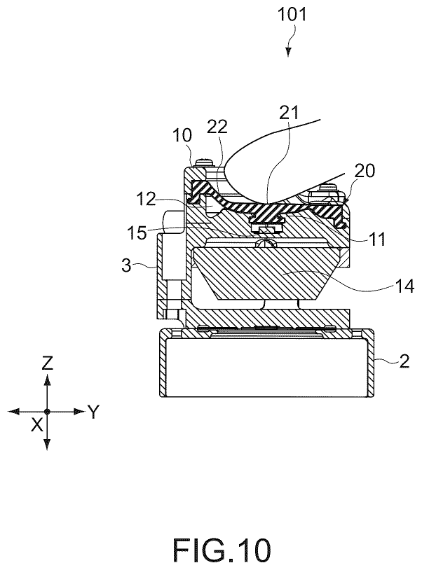

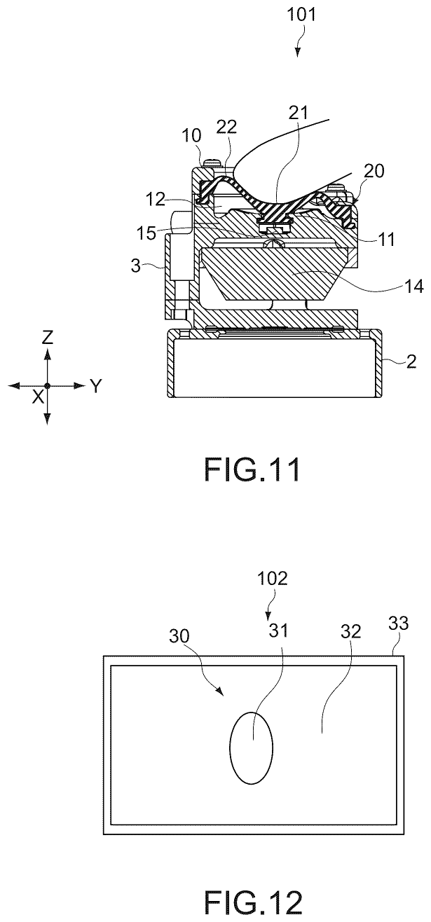

Next, an application example of the present technology will be described. FIG. 7 is a perspective view showing a haptic presentation device 101 according to the application example. FIG. 8 and FIG. 9 are each a cross-sectional view of the haptic presentation device 101 according to the application example as viewed from the front. FIG. 10 and FIG. 11 are each a cross-sectional view of the haptic presentation device 101 according to the application example as viewed from the side.

In FIG. 7, illustration of the film portion 20 is omitted. Further, FIG. 8 and FIG. 10 each show the initial state of the deformable portion 22, and FIG. 9 and FIG. 11 each show the deformed state of the deformable portion 22. Note that in FIG. 7 to FIG. 11, the fluid drive unit 13 and the control device 16 are omitted.

Since the haptic presentation device 101 according to the application example has a configuration similar to that of the above-mentioned haptic presentation device 100 according to the first embodiment in principle, differences from the first embodiment and the like will be mainly described.

The haptic presentation device 100 according to the application example is an installation-type device that is installed on a table or the like and used. This haptic presentation device 100 includes a base 2 installed on a table or the like, three columns 3 provided on the base 2, and a casing 10 provided on the three columns 3.

The base 2 is configured to have a cylindrical shape with a top surface. Note that the shape of the base 2 may be an ellipse, a polygon, a star shape, or the like, and the shape is not particularly limited. Note that in the case where the haptic presentation device 100 is of a wearable-type, the base 2 can be omitted.

Although the casing 10 is configured to have a cylindrical shape, a wall portion on the rear side (right side in FIGS. 10 and 11) of the cylinder is cut out (missing). Since this cutout is provided, a user can easily place his/her finger on the film portion 20 inside the casing 10.

The support portion 11 that supports the fixed portion 21 in the film portion 20 is provided at the center position (XY direction) on the bottom portion of the casing 10. The sensor unit 15 is provided at a position corresponding to the support portion 11. Further, the output unit 14 is provided below the support portion 11. The output unit 14 is disposed at a position below the support portion 11 outside the casing 10 and is disposed in a space surrounded by the three columns 3.

The film portion 20 includes the fixed portion 21 and the deformable portion 22. The fixed portion 21 includes a fitting portion that fits into the support portion 11 on the lower side thereof.

The deformable portion 22 has a thickness that gradually decreases from the inner peripheral side to the outer peripheral side. The outer peripheral end of the deformable portion 22 is fixed to the inner peripheral wall of the casing 10. Here, with reference to FIG. 8 and FIG. 10, the outer peripheral end of the deformable portion 22 on the rear side (right side in FIG. 10) has the same height as the fixed portion 21 in the initial state. Meanwhile, the outer peripheral end on the front side (left side in FIG. 10) and the outer peripheral ends on the right and left sides (right and left direction in FIG. 8) of the deformable portion 22 are located at positions higher than the fixed portion 21 in the initial state.

That is, the deformable portion 22 includes a first portion (rear) having a first height in the initial state and second portions (front and right and left direction) having a height higher than the first height in the initial state. This makes it possible to appropriately deform the deformable portion 22 in accordance with the shape and curvature of the user's finger.

The fluid holding portion 12 is provided below the deformable portion 22. The space formed by the fluid holding portion 12 is a region surrounded by the back surface of the deformable portion 22, the bottom surface of the casing 10, the inner wall surface of the casing 10, and the outer peripheral surface of the support portion 11.

### Effects, etc.

As described above, the haptic presentation device 100 according to the present technology (including the application example 101) includes the fixed portion 21 and the deformable portion 22. The fixed portion 21 is capable of coming into contact with a body of a user. The deformable portion 22 has an inner peripheral side (first side) that is as side closer to the fixed portion 21 and an outer peripheral side (second side) that is a side farther from the fixed portion 21 and has rigidity lower than rigidity of the inner peripheral side (is likely to deform because the thickness is thin), and is capable of coming into contact with a body of a user by deformation.

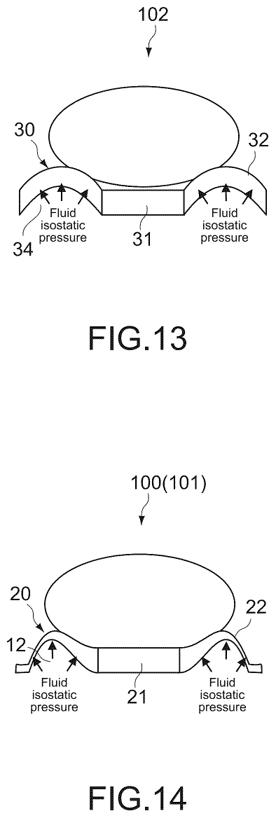

This effect will be described by comparison with Comparative Example. FIG. 12 is a top view showing a haptic presentation device 102 according to Comparative Example. FIG. 13 is a side view showing the deformed state of the haptic presentation device 102 according to Comparative Example.

The haptic presentation device 102 according to Comparative Example includes a rectangular plate member 33 and a rectangular film portion 30 provided on the plate member 33. The film portion 30 is formed of, for example, a material having relatively high stretchability, such as a rubber material. The outer peripheral end of the film portion 30 is bonded to the plate member 33 using an adhesive or the like, and the central portion of the film portion 30 is bonded to the plate member 33 using an adhesive or the like. In the film portion 30, the center portion fixed to the plate member 33 is a fixed portion 31 and a portion therearound is a deformable portion 32. Further, the space sandwiched between the deformable portion 32 and the plate member 33 is a fluid holding portion 34.

When fluid flows into the fluid holding portion 34, the deformable portion 32 deforms as shown in FIG. 13. At this time, the fluid in the fluid holding portion 34 deforms the deformable portion 32 by isostatic pressure.

In Comparative Example, since the thickness of the deformable portion 32 is constant (rigidity and ease of deformation are constant), the deformable portion 32 does not deform in accordance with the shape and curvature of the finger. Therefore, the pressure on the user's finger is not constant, which gives the user a sense of discomfort. Further, in Comparative Example, since in the deformable portion 32, a sharp height difference greater than the curvature of the finger occurs in the vicinity of the fixed portion 31, there is also a problem that the finger is separated from the fixed portion 31.

FIG. 14 is a diagram showing the deformed state of the deformable portion 22 according to the present technology. When fluid flows into the fluid holding portion 12, the deformable portion 22 deforms as shown in FIG. 14. At this time, the fluid in the fluid holding portion 12 deforms the deformable portion 22 by isostatic pressure.

In the present technology, since the thickness of the deformable portion 22 is not constant (rigidity and ease of deformation are not constant), the deformable portion 22 deforms in accordance with the shape and curvature of the finger. Therefore, the pressure on the user's finger is constant, which makes it possible to prevent it from giving the user a sense of discomfort. That is, it is possible to effectively present hard and soft sensations to the user. Further, in the present technology, in the deformable portion 22, no sharp height difference greater than the curvature of the finger occurs in the vicinity of the fixed portion 21. Therefore, the problem that the finger is separated from the fixed portion 21 is also solved.

Further, in this embodiment, the deformable portion 22 is switched between an initial state (first state) and a deformed state (second state) by deformation, the front surface of the deformable portion 22 being in contact with a body of a user over a first area in the initial state, the front surface of the deformable portion 22 being in contact with the body of the user over a second area larger than the first area in the deformed state.

By switching between the initial state and the deformed state, it is possible to effectively present a feeling of hardness and softness to the user. That is, the deformable portion 22 is set to the initial state in the case where it is desired to present a hard haptic sensation, and the deformable portion 22 is set to the deformed state in the case where it is desired to present a soft haptic sensation.

Further, by switching between the initial state and the deformed state at a predetermined period, it is possible to effectively present vibration (e.g., 20 Hz or less) to the user.

Further, in this embodiment, the output unit 14 that presents a sensation to a user via the fixed portion 21 is provided. By combining presentation of a sensation by this output unit 14 and presentation of a haptic sensation by deformation of the deformable portion 22, it is possible to present various sensations to the user (see Second Example to Third Example).

In particular, it is possible to present vibration in a wide band to the user by presenting vibration in a first frequency band (e.g., less than 20 Hz) by switching between the initial state and the deformed state and presenting vibration in a second frequency band (20 Hz or more) higher than the first frequency band by vibration of the vibration generation unit.

Further, the control unit switches between the initial state and the deformed state on the basis of predetermined information (control information based on video information, sensor information of the sensor unit 15, or the like), making it possible to appropriately present hard and soft sensations and vibration to the user (see First Example to Third Example).

Further, the control unit presents a sensation to the user by the output unit 14 on the basis of predetermined information (control information based on video information, sensor information of the sensor unit 15, or the like), making it possible to present various sensations to the user (see Second Example to Third Example).

Further, in this embodiment, the sensor unit 15 that detects an action of the user on the fixed portion 21 is provided.

The control unit switches between the initial state and the deformed state on the basis of this sensor information, making it possible to appropriately present hard and soft sensations and vibration to the user (see First Example and Third Example). Further, the control unit presents a sensation to the user by the output unit 14 on the basis of this sensor information, making it possible to appropriately present various sensations to the user (see Third Example).

### Various Modified Examples

Next, various modified examples in the present technology will be described.

### First Modified Example

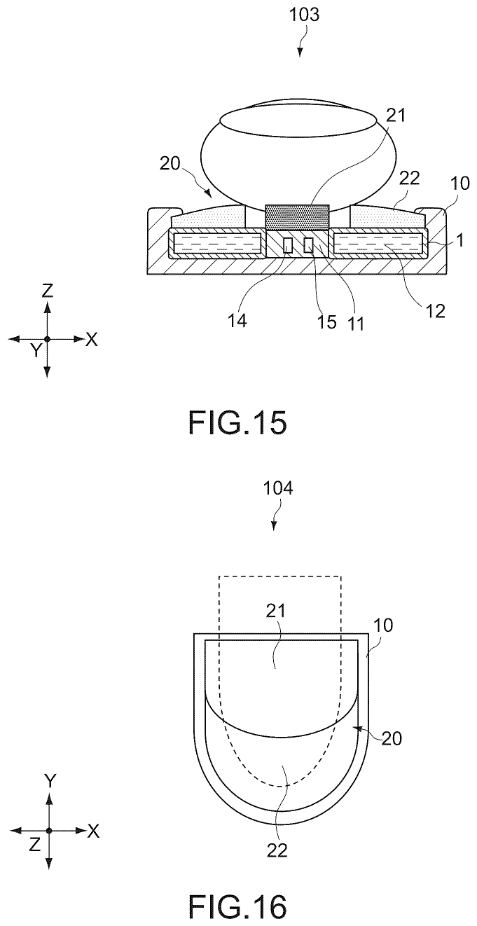

FIG. 15 is a diagram showing a haptic presentation device 103 according to a first modified example. A case where the outer peripheral side of the fixed portion 21 and the inner peripheral side of the deformable portion 22 are connected to each other has been described above. Meanwhile, in the first modified example, the outer peripheral side of the fixed portion 21 and the inner peripheral side of the deformable portion 22 are not connected at least in part.

### Second Modified Example and Third Modified Example

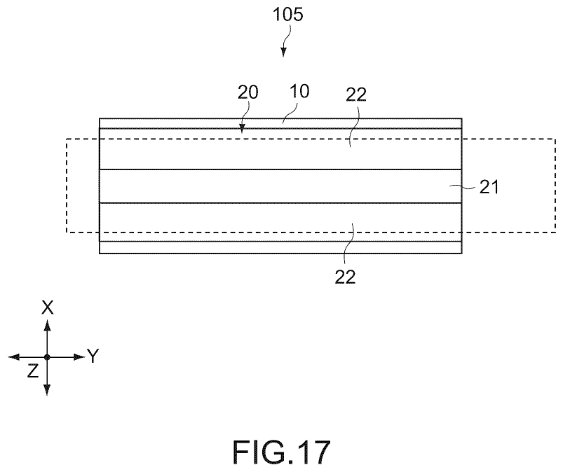

FIG. 16 is a diagram showing a haptic presentation device 104 according to a second modified example. FIG. 17 is a diagram showing a haptic presentation device 105 according to a third modified example. A case where the deformable portion 22 surrounds the entire circumference of the fixed portion 21 has been described above. Meanwhile, in the second modified example and the third modified example, the deformable portion 22 surrounds part of the periphery of the fixed portion 21.

In the second modified example, the deformable portion 22 surrounds the fixed portion 21 on the front side corresponding to the fingertip. In the third modified example, the fixed portion 21 is provided in a band shape, and two band-shaped deformable portions 22 are provided at positions sandwiching the fixed portion 21. Note that in the third modified example, long parts such as a finger, an arm, and a leg are assumed as the body of the user.

### Fourth Modified Example

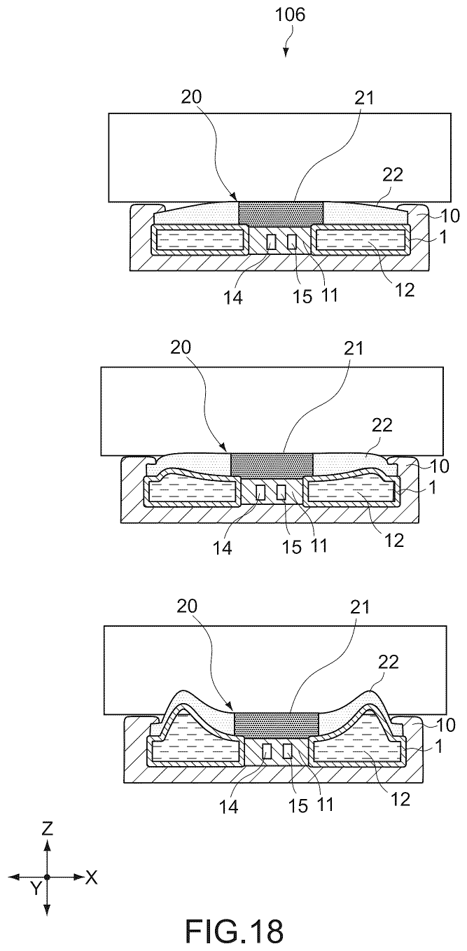

FIG. 18 is a diagram showing a haptic presentation device 106 according to a fourth modified example. A case where the body of the user is smaller than the deformable portion 22 and the deformable portion 22 deforms in accordance with the shape and curvature of the body of the user has been described above. Meanwhile, in the fourth modified example, the body of the user is larger than the deformable portion 22 and the deformable portion 22 deforms independently of the shape and curvature of the body of the user.

The upper diagram in FIG. 18 shows a case where the deformable portion 22 is in the initial state and shows a state in which the body of the user is in contact with the fixed portion 21 but not much in contact with the deformable portion 22.

The center diagram in FIG. 18 shows a case where the deformable portion 22 is in the deformed state in which it is slightly deformed, and shows a state in which the body of the user is in contact with the fixed portion 21 and the deformable portion 22. Further, the lower diagram in FIG. 18 shows a case where the deformable portion 22 is in the deformed state in which it is largely deformed, and shows a state in which the body of the user is compressed by the deformable portion 22.

### Fifth Modified Example

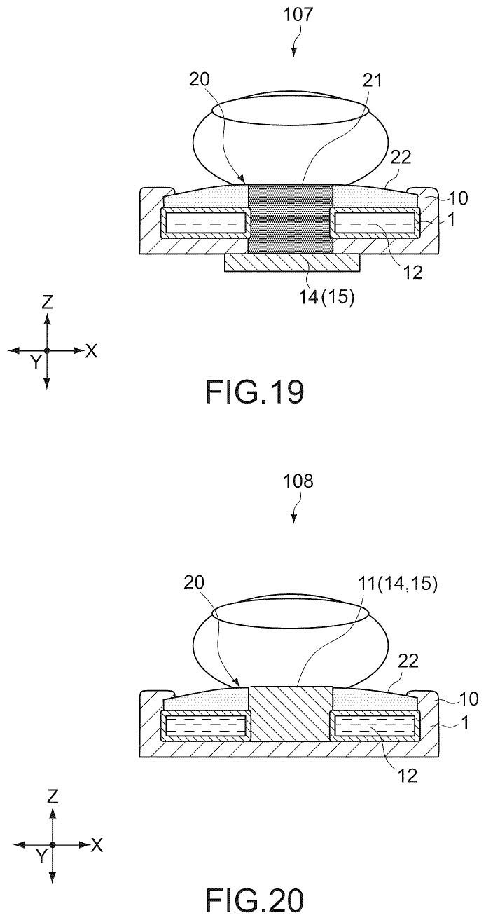

FIG. 19 is a diagram showing a haptic presentation device 107 according to a fifth modified example. In the fifth modified example, the fixed portion 21 is long in the up-and-down direction and communicates with the lower side of the casing 10, and the output unit 14 or the sensor unit 15 is provided at a position corresponding to the fixed portion 21 outside the casing 10.

### Sixth Modified Example

FIG. 20 is a diagram showing a haptic presentation device 108 according to a sixth modified example. In the sixth modified example, the support portion 11, a hard output unit 14, or a hard sensor unit 15 is exposed upward, which also functions as the fixed portion 21.

The present technology may take the following configurations.

(1) A haptic presentation device, including:
a fixed portion that is capable of coming into contact with a body of a user; and
a deformable portion that includes a first side that is a side closer to the fixed portion and a second side that is a side farther from the fixed portion and has rigidity lower than rigidity of the first side, and is capable of coming into contact with the body of the user by deformation.
   (2) The haptic presentation device according to (1) above, in which
the deformable portion has a predetermined thickness in a height direction and is deformable so as to protrude toward the height direction.
   (3) The haptic presentation device according to (2) above, in which
a thickness of the second side is thinner than a thickness of the first side.
   (4) The haptic presentation device according to (3) above, in which
the deformable portion has a thickness that gradually decreases from the first side to the second side.
   (5) The haptic presentation device according to any one of (2) to (4) above, in which
the deformable portion has a first surface that is capable of coming into contact with the body of the user, and
the deformable portion is switched between a first state and a second state by deformation, the first surface being in contact with the body of the user over a first area in the first state, the first surface being in contact with the body of the user over a second area larger than the first area in the second state.
   (6) The haptic presentation device according to (5) above, in which
a feeling of hardness and softness is presented to the user by switching between the first state and the second state.
   (7) The haptic presentation device according to (5) or (6) above, in which
vibration is presented to the user by switching between the first state and the second state.
   (8) The haptic presentation device according to any one of (5) to (7), in which
the deformable portion protrudes in the height direction in the second state more than in the first state.
   (9) The haptic presentation device according to (8) above, in which
the second side of the deformable portion protrudes in the height direction more than the first side in the second state.
   (10) The haptic presentation device according to any one of (5) to (9) above, in which
the deformable portion includes a first portion and a second portion, the first portion having a first height in the first state, the second portion having a height lower than the first height in the first state.
   (11) The haptic presentation device according to any one of (5) to (10) above, in which
the deformable portion has a first back surface opposite to the first surface, the haptic presentation device further including:
a fluid holding portion that is capable of holding fluid and provided on a side of the first back surface of the deformable portion; and
a fluid drive unit that switches between the first state and the second state by changing pressure of the fluid in the fluid holding portion.
   (12) The haptic presentation device according to any one of (5) to (11) above, in which
the fixed portion has a second surface that is capable of coming into contact with the body of the user and a second back surface opposite to the second surface, the haptic presentation device further including
a support portion that supports and fixes the fixed portion from a side of the second back surface.
   (13) The haptic presentation device according to any one of (5) to (12) above, further including
an output unit that presents a sensation to the user via the fixed portion.
   (14) The haptic presentation device according to (13) above, in which
the output unit includes at least one of a vibration generation unit that generates vibration, a temperature change unit that changes temperature, a pressure generation unit that generates pressure, a sound output unit that outputs sound, or a light-emitting unit that generates light.
   (15) The haptic presentation device according to (14) above, in which
the output unit includes the vibration generation unit, and
the haptic presentation device presents vibration in a first frequency band to the user by switching between the first state and the second state and presents vibration in a second frequency band different from the first frequency band to the user by vibration of the vibration generation unit.
   (16) The haptic presentation device according to any one of (13) to (15) above, further including
a control unit that executes, on a basis of predetermined information, switching between the first state and the second state or presentation of a sensation to the user by the output unit.
   (17) The haptic presentation device according to any one of (5) to (16) above, further including
a sensor unit that detects an action of the user on the fixed portion.
   (18) The haptic presentation device according to (17) above, in which
the sensor unit includes at least one of a proximity sensor, a vibration sensor, a temperature sensor, a pressure sensor, a sound sensor, a sound detection sensor, or a light receiving sensor.
   (19) The haptic presentation device according to (17) or (18) above, further including
a control unit that switches between the first state and the second state on a basis of information from the sensor unit.
   (20) The haptic presentation device according to any one of (1) to (19) above, in which
the deformable portion is disposed so as to surround the fixed portion.

### REFERENCE SIGNS LIST

10 casing
11 support portion
12 fluid holding portion
13 fluid drive unit
14 output unit
15 sensor unit
16 control device
20 film portion
21 fixed portion
22 deformable portion
100, 101, 103˜108 haptic presentation device

1. A haptic presentation device, comprising:
a fixed portion that is capable of coming into contact with a body of a user; and
a deformable portion that includes a first side that is a side closer to the fixed portion and a second side that is a side farther from the fixed portion and has rigidity lower than rigidity of the first side, and is capable of coming into contact with the body of the user by deformation.

2. The haptic presentation device according to claim 1, wherein
the deformable portion has a predetermined thickness in a height direction and is deformable so as to protrude toward the height direction.

3. The haptic presentation device according to claim 2, wherein
a thickness of the second side is thinner than a thickness of the first side.

4. The haptic presentation device according to claim 3, wherein
the deformable portion has a thickness that gradually decreases from the first side to the second side.

5. The haptic presentation device according to claim 2, wherein
the deformable portion has a first surface that is capable of coming into contact with the body of the user, and
the deformable portion is switched between a first state and a second state by deformation, the first surface being in contact with the body of the user over a first area in the first state, the first surface being in contact with the body of the user over a second area larger than the first area in the second state.

6. The haptic presentation device according to claim 5, wherein
a feeling of hardness and softness is presented to the user by switching between the first state and the second state.

7. The haptic presentation device according to claim 5, wherein
vibration is presented to the user by switching between the first state and the second state.

8. The haptic presentation device according to claim 5, wherein
the deformable portion protrudes in the height direction in the second state more than in the first state.

9. The haptic presentation device according to claim 8, wherein
the second side of the deformable portion protrudes in the height direction more than the first side in the second state.

10. The haptic presentation device according to claim 5, wherein
the deformable portion includes a first portion and a second portion, the first portion having a first height in the first state, the second portion having a height lower than the first height in the first state.

11. The haptic presentation device according to claim 5, wherein
the deformable portion has a first back surface opposite to the first surface, the haptic presentation device further comprising:
a fluid holding portion that is capable of holding fluid and provided on a side of the first back surface of the deformable portion; and
a fluid drive unit that switches between the first state and the second state by changing pressure of the fluid in the fluid holding portion.

12. The haptic presentation device according to claim 5, wherein
the fixed portion has a second surface that is capable of coming into contact with the body of the user and a second back surface opposite to the second surface, the haptic presentation device further comprising
a support portion that supports and fixes the fixed portion from a side of the second back surface.

13. The haptic presentation device according to claim 5, further comprising
an output unit that presents a sensation to the user via the fixed portion.

14. The haptic presentation device according to claim 13, wherein
the output unit includes at least one of a vibration generation unit that generates vibration, a temperature change unit that changes temperature, a pressure generation unit that generates pressure, a sound output unit that outputs sound, or a light-emitting unit that generates light.

15. The haptic presentation device according to claim 14, wherein
the output unit includes the vibration generation unit, and
the haptic presentation device presents vibration in a first frequency band to the user by switching between the first state and the second state and presents vibration in a second frequency band different from the first frequency band to the user by vibration of the vibration generation unit.

16. The haptic presentation device according to claim 13, further comprising
a control unit that executes, on a basis of predetermined information, switching between the first state and the second state or presentation of a sensation to the user by the output unit.

17. The haptic presentation device according to claim 5, further comprising
a sensor unit that detects an action of the user on the fixed portion.

18. The haptic presentation device according to claim 17, wherein
the sensor unit includes at least one of a proximity sensor, a vibration sensor, a temperature sensor, a pressure sensor, a sound sensor, a sound detection sensor, or a light receiving sensor.

19. The haptic presentation device according to claim 17, further comprising
a control unit that switches between the first state and the second state on a basis of information from the sensor unit.

20. The haptic presentation device according to claim 1, wherein
the deformable portion is disposed so as to surround the fixed portion.
